(19) United States
(12) Patent Application Publication
(10) Pub. No.: US 2025/0121889 A1
(43) Pub. Date: Apr. 17, 2025

(54) ELECTRIC VEHICLE STRUCTURE

(71) Applicants: HYUNDAI MOTOR COMPANY, SEOUL (KR); KIA CORPORATION, SEOUL (KR)

(72) Inventors: Seung Min Jeong, Hwaseong-si (KR); Gun Woo Ko, Seongnam-si (KR)

(73) Assignees: HYUNDAI MOTOR COMPANY, SEOUL (KR); KIA CORPORATION, SEOUL (KR)

(21) Appl. No.: 18/652,318

(22) Filed: May 1, 2024

(30) Foreign Application Priority Data
Oct. 12, 2023 (KR) 10-2023-0135836

(51) Int. Cl. B62D 25/02; B60K 1/04; B62D 25/20

(52) U.S. Cl. CPC B62D 25/025; B60K 1/04; B62D 25/2036; B60K 2001/0438

(57) ABSTRACT

An electric vehicle structure includes side sills disposed on both sides of a vehicle body, a floor panel fixed at both side ends thereof to the side sills, a battery tray coupled to the lower sides of the side sills to define a battery accommodation space together with the floor panel, an integrated-battery front cross member elongated in the lateral direction of the vehicle body so as to be coupled at both ends thereof to the side sills and to interconnect the front side of the battery tray and the floor panel, and a dash cross member connected to the floor panel and the front upper side of the integrated-battery front cross member and elongated in the lateral direction of the vehicle body.

### CROSS REFERENCE TO RELATED APPLICATIONS

This application claims priority from Korean Patent Application No. 10-2023-0135836, filed on Oct. 12, 2023, in the Korean Intellectual Property Office, the disclosure of which is incorporated herein by reference in its entirety.

### BACKGROUND

### 1. Field

The present disclosure relates to a structure of an electric vehicle.

### 2. Description of the Related Art

An electric vehicle is configured to be driven by driving a motor using electricity supplied from a battery mounted therein.

Therefore, the cruising range of an electric vehicle greatly depends on the energy storage capacity of a battery mounted therein.

The main trend in development of electric vehicles is to secure performance against various types of collisions while mounting batteries in electric vehicles so as to provide as large an amount of electrical energy as possible.

The information disclosed in this Background of the Disclosure section is only for enhancement of understanding of the general background of the disclosure, and should not be taken as an acknowledgement or any form of suggestion that this information forms the related art already known to a person skilled in the art.

### SUMMARY

Therefore, the present disclosure has been made in view of the above problems, and it is an object of the present disclosure to provide an electric vehicle structure capable of increasing the cruising range of a vehicle by increasing the number of batteries mounted therein while minimizing increase in the weight of a vehicle body and securing performance against various types of collisions of the vehicle.

In accordance with the present disclosure, the above and other objects can be accomplished by an electric vehicle structure including side sills disposed on both sides of a vehicle body, a floor panel fixed at both side ends thereof to the side sills, a battery tray coupled to the lower sides of the side sills to define a battery accommodation space together with the floor panel, an integrated-battery front cross member elongated in the lateral direction of the vehicle body so as to be coupled at both ends thereof to the side sills and to interconnect the front side of the battery tray and the floor panel, and a dash cross member connected to the floor panel and the front upper side of the integrated-battery front cross member and elongated in the lateral direction of the vehicle body.

The dash cross member may have a sectional shape in which a plurality of closed sections is connected to each other, and may be provided so as to protrude ahead of a dash panel.

The dash cross member may have a shape covering both the upper surface of the floor panel and the front surface of the integrated-battery front cross member, and may be coupled to the floor panel and the integrated-battery front cross member.

The electric vehicle structure may further include front side members connected to the front side of the dash cross member, and the dash cross member may be connected at both ends thereof to A-pillars coupled at lower ends thereof to the side sills.

The electric vehicle structure may further include a front sub-frame provided under the front side members, and the front sub-frame may be mounted such that rear end portions thereof are supported on the lower side of the dash cross member.

The dash cross member may be connected to the A-pillars through dash cross extensions.

The front side members may be coupled to the dash cross member through front side rear lower members coupled to the rear sides of the front side members, and the front side rear lower members may be coupled at rear sides thereof to the dash cross member and the integrated-battery front cross member.

The dash cross member may be disposed so as to have a sectional shape extending from the floor panel and the front upper side of the integrated-battery front cross member toward the rear sides of the front side members, and the front side rear lower members may be formed so as to extend from the rear sides of the front side members and to expand in an upward-downward direction so as to cover the front, upper, and lower sides of the dash cross member.

The electric vehicle structure may further include extension side members coupled to the front side rear lower members and the dash cross extensions so as to connect the front side members to the A-pillars while defining closed spaces surrounding end portions of the dash cross member.

The dash cross extensions may be integrally formed with extension upper member portions curved in a shape extending in a direction from the front side of the vehicle body toward the rear upper side of the vehicle body while defining closed spaces together with the extension side members and extension lower member portions curved in a shape extending in a direction from the front side of the vehicle body toward the rear lower side of the vehicle body.

The extension side members may be integrally formed with extension side front upper member portions curved in a shape extending in a direction from the front side of the vehicle body toward the rear upper side of the vehicle body while corresponding to the extension upper member portions of the dash cross extensions.

The battery tray may be provided with a battery lower module inner cross member spaced backward from the integrated-battery front cross member and elongated in the lateral direction of the vehicle body, the floor panel may be provided with a floor cross member disposed on the battery lower module inner cross member and elongated in the lateral direction of the vehicle body, and the floor cross member may be coupled to the battery lower module inner cross member.

The electric vehicle structure may further include a dash upper member elongated in the forward-backward direction of the vehicle body and coupled between the dash cross member and the floor cross member.

The floor panel may be formed of an extruded material in a shape in which a plurality of closed sections is connected to each other, and the floor cross member may be integrally formed with the floor panel by the highest protruding closed section among the closed sections of the floor panel.

The battery accommodation space may be provided behind the battery lower module inner cross member.

The battery tray may be provided with lower module outer side members, a lower module outer front cross member, and a lower module outer rear cross member to surround the outer periphery of the battery accommodation space, and the electric vehicle structure may further include a gasket provided on each of the upper surfaces of the lower module outer side members, the lower module outer front cross member, and the lower module outer rear cross member.

The lower module outer front cross member located on the front side of the battery tray may be coupled to the lower side of the integrated-battery front cross member, with the gasket interposed therebetween. The lower module outer rear cross member located on the rear side of the battery tray may be coupled to the lower side of the integrated-battery rear cross member, with the gasket interposed therebetween. The lower module outer side members of the battery tray may be coupled to the lower sides of the side sills, with the gasket interposed therebetween.

### BRIEF DESCRIPTION OF THE FIGURES

The above and other objects, features and other advantages of the present disclosure will be more clearly understood from the following detailed description taken in conjunction with the accompanying drawings, in which:

FIG. 1 is a view showing an electric vehicle structure according to the present disclosure;

FIG. 2 is a view showing the front portion of the vehicle body shown in FIG. 1 in detail;

FIG. 3 is a view showing the front portion of the vehicle body when viewed from an angle different from that in FIG. 2;

FIG. 4 is a detailed view of FIG. 2, from which side sills are removed;

FIG. 5 is a cross-sectional view taken along line V-V in FIG. 2;

FIG. 6 is a cross-sectional view taken along line VI-VI in FIG. 2;

FIG. 7 is a cross-sectional view of the rear portion of the vehicle body connected to the structure shown in FIG. 5;

FIG. 8 is a side view of the vehicle body of the present disclosure, which shows transmission of load from a front side member toward the rear side of the vehicle body in a dispersed fashion; and

FIGS. 9 and 10 are bottom views of the vehicle body of the present disclosure, which shows transmission of load from the front side member toward the rear side of the vehicle body in a dispersed fashion.

### DETAILED DESCRIPTION

Hereinafter, the embodiments disclosed in the present specification will be described in detail with reference to the accompanying drawings, and the same or similar elements are denoted by the same reference numerals even though they are depicted in different drawings, and redundant descriptions thereof will be omitted.

In the following description, with respect to constituent elements used in the following description, the suffixes “module” and “unit” are used only in consideration of facilitation of description, and do not have mutually distinguished meanings or functions.

In the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

It will be further understood that the terms “comprises”, “comprising”, “includes”, and/or “including”, when used herein, specify the presence of stated features, integers, steps, operations, elements, components, or combinations thereof, but do not preclude the presence or addition of one or more other features, integers, steps, operations, elements, components, or combinations thereof.

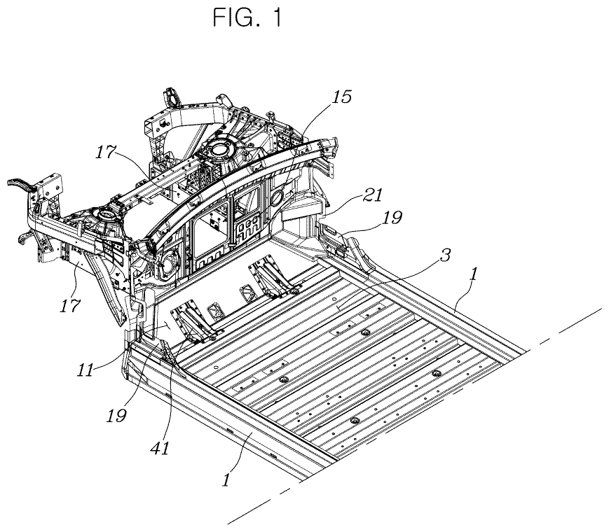

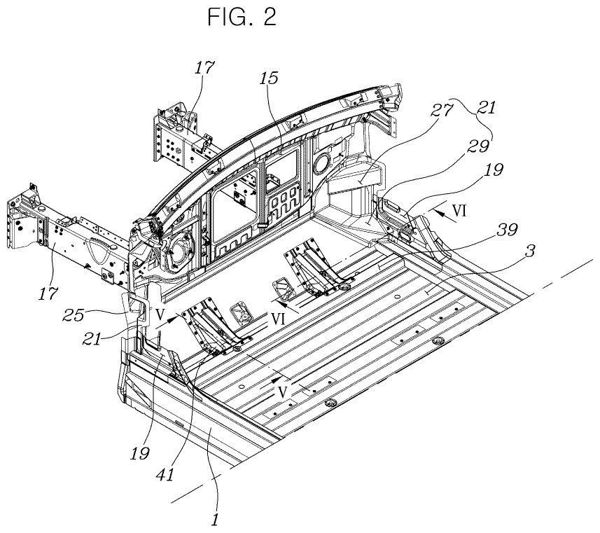

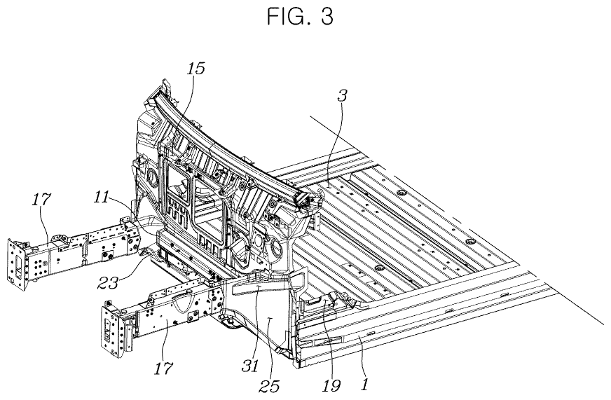

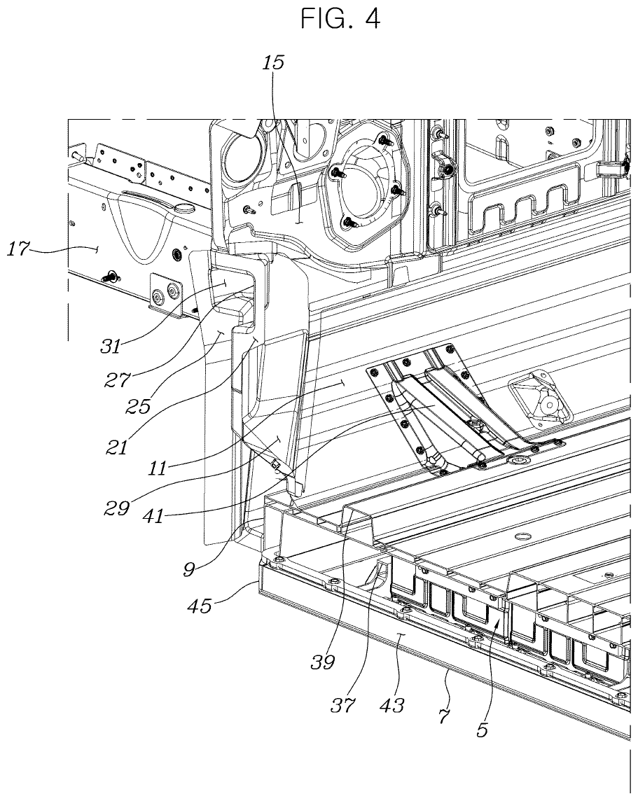

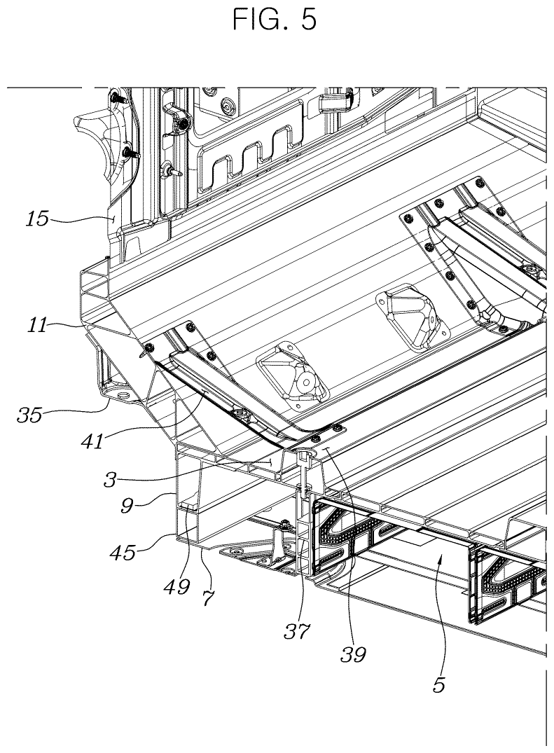

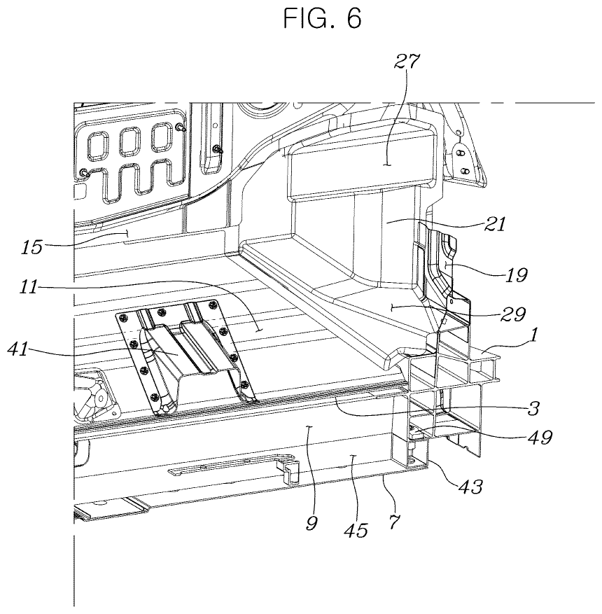

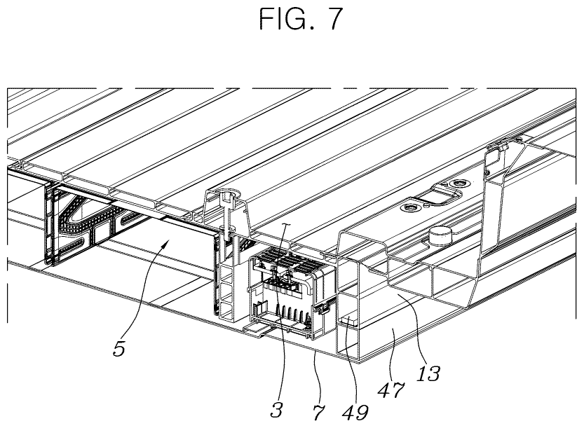

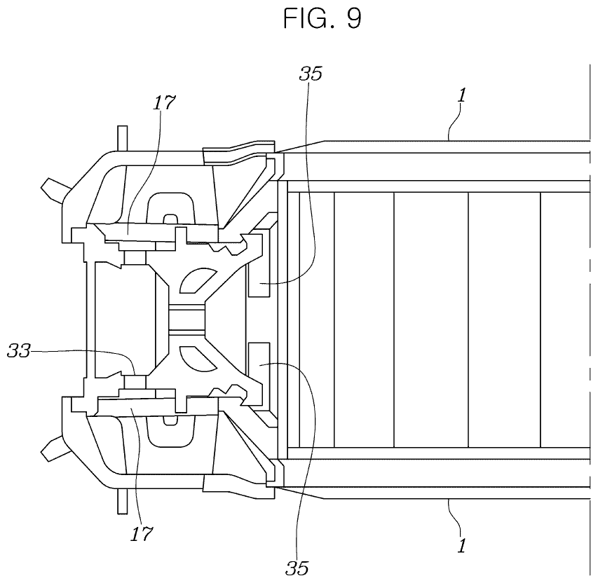

Referring to FIGS. 1 to 10, an electric vehicle structure according to an embodiment of the present disclosure includes side sills 1 disposed on both sides of a vehicle body, a floor panel 3 fixed at both side ends thereof to the side sills 1, a battery tray 7 coupled to lower sides of the side sills 1 to define a battery accommodation space 5 together with the floor panel 3, an integrated-battery front cross member 9 elongated in the lateral direction of the vehicle body so as to be coupled at both ends thereof to the side sills 1 and to interconnect the front side of the battery tray 7 and the floor panel 3, and a dash cross member 11 connected to the floor panel 3 and the front upper side of the integrated-battery front cross member 9 and elongated in the lateral direction of the vehicle body.

That is, in the electric vehicle structure of the present disclosure, the floor panel 3 and the battery tray 7 serve to form upper and lower sides of the battery accommodation space 5, the side sills 1 serve to form both sides of the battery accommodation space 5, and the integrated-battery front cross member 9 and an integrated-battery rear cross member 13 serve to seal the front side and the rear side of the battery accommodation space 5.

According to the present disclosure, there is no structure such as a separate battery pack accommodating battery cells, unlike the conventional art. That is, the floor panel 3 and the side sills 1, which are basic constituent parts of the vehicle body, form the battery accommodation space 5 accommodating battery cells, whereby battery cells are directly mounted in the vehicle body. Accordingly, more battery cells may be mounted in the vehicle body having a given size, and the weight of the vehicle may be reduced due to elimination of unnecessary parts. Consequently, the electric vehicle structure of the present disclosure may greatly contribute to increase in the cruising range of the vehicle.

The dash cross member 11 has a sectional shape in which a plurality of closed sections is connected to each other, and is provided so as to protrude ahead of a dash panel 15.

In addition, the dash cross member 11 has a shape covering both the upper surface of the floor panel 3 and the front surface of the integrated-battery front cross member 9, and is coupled to the floor panel 3 and the integrated-battery front cross member 9.

Accordingly, the dash cross member 11 has structural characteristics that are robust to impact applied from the front side of the vehicle body by dispersing the impact to the integrated-battery front cross member 9 and the floor panel 3.

Front side members 17 are connected to the front side of the dash cross member 11, and the dash cross member 11 is connected at both ends thereof to A-pillars 19 coupled at lower ends thereof to the side sills 1.

That is, the lower ends of the A-pillars 19 are coupled to the upper sides of the side sills 1, and both ends of the dash cross member 11 are connected to the side sills 1 and the A-pillars 19.

For reference, only lower portions of the A-pillars 19 are shown in the drawings.

In this embodiment, the dash cross member 11 is connected to the A-pillars 19 through dash cross extensions 21.

The dash cross extensions 21 are members that are provided on both sides of the dash cross member 11 and extend from the dash cross member 11 in the lateral direction and the backward direction so as to be connected to the A-pillars 19 and the side sills 1.

The front side members 17 are coupled to the dash cross member 11 through front side rear lower members 23 coupled to the rear sides of the front side members 17, and the front side rear lower members 23 are coupled at rear sides thereof to the dash cross member 11 and the integrated-battery front cross member 9.

Therefore, load applied from the front side of the vehicle body through the front side members 17 is supported by the dash cross member 11 through the front side rear lower members 23, and is also supported by the integrated-battery front cross member 9.

In addition, the dash cross member 11 is disposed so as to have a sectional shape that extends from the floor panel 3 and the front upper side of the integrated-battery front cross member 9 toward the rear sides of the front side members 17. The front side rear lower members 23 are formed so as to extend from the rear sides of the front side members 17 and to expand in the upward-downward direction so as to cover the front, upper, and lower sides of the dash cross member 11.

Therefore, load applied from the front side of the vehicle body through the front side members 17 is transmitted downward from the front side rear lower members 23 toward the dash cross member 11 and the integrated-battery front cross member 9, and is also transmitted upward in a dispersed fashion to be supported by the A-pillars 19.

In addition, there are provided extension side members 25 coupled to the front side rear lower members 23 and the dash cross extensions 21 so as to connect the front side members 17 to the A-pillars 19 while defining closed spaces surrounding end portions of the dash cross member 11.

The dash cross extensions 21 are integrally formed with extension upper member portions 27, which are curved in a shape extending in a direction from the front side of the vehicle body toward the rear upper side of the vehicle body while defining closed spaces together with the extension side members 25, and extension lower member portions 29, which are curved in a shape extending in a direction from the front side of the vehicle body toward the rear lower side of the vehicle body.

In addition, the extension side members 25 are integrally formed with extension side front upper member portions 31, which are curved in a shape extending in a direction from the front side of the vehicle body toward the rear upper side of the vehicle body while corresponding to the extension upper member portions 27 of the dash cross extensions 21.

Therefore, load applied from the front side of the vehicle body through the front side members 17 is firmly supported by closed space structures formed by the front side rear lower members 23, the dash cross extensions 21, and the extension side members 25. In particular, the curved sectional structures formed by the extension upper member portions 27, the extension lower member portions 29, and the extension side front upper member portions 31 effectively support load transmitted toward the rear side of the vehicle body through the front side members 17 in a dispersing fashion, as described above, thereby securing high structural robustness, i.e., improved performance against frontal collision of the vehicle. This means that the battery cells disposed behind the integrated-battery front cross member 9 may be protected more safely.

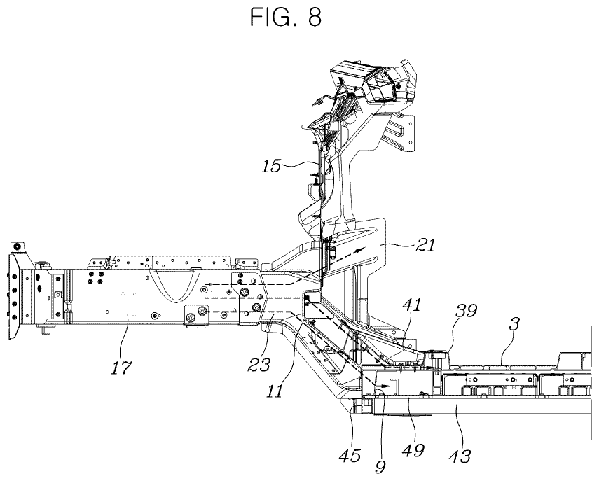

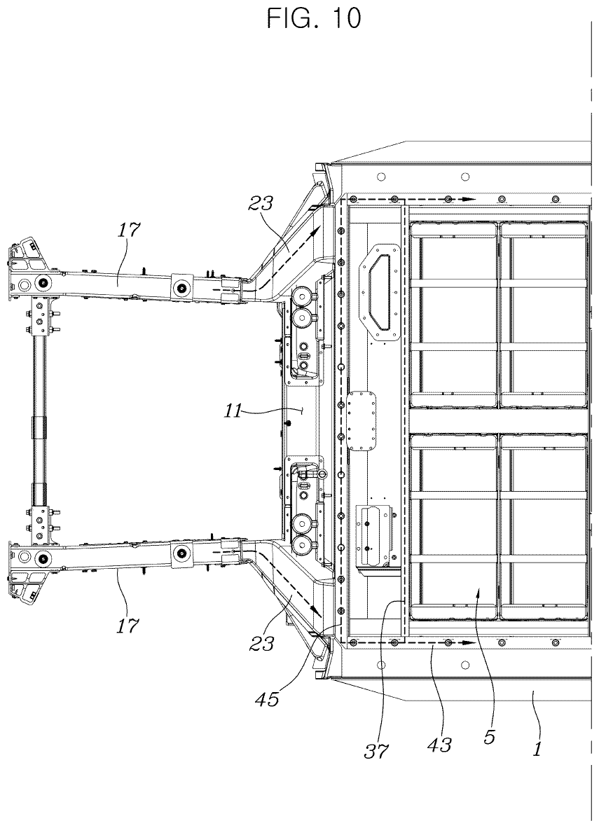

Transmission of load applied from the front side of the vehicle body through the front side members 17 toward the rear side of the vehicle body in a dispersed fashion is indicated by the arrows in FIGS. 8 and 10.

Front sub-frame 33 is provided under the front side members 17, and the rear end portions of the front sub-frame 33 is mounted so as to be supported on the lower side of the dash cross member 11.

In this embodiment, the rear end portions of the front sub-frame 33 is supported on the lower side of the dash cross member 11 through front sub-frame mounting brackets 35.

Therefore, in the event of frontal collision of the vehicle, the front sub-frame mounting brackets 35 and the dash cross member 11 suppress the front sub-frame 33 from being pushed backward.

For reference, electrically-driven parts such as a motor are mounted on the front sub-frame 33.

Meanwhile, the battery tray 7 is provided with a battery lower module inner cross member 37 spaced backward from the integrated-battery front cross member 9 and elongated in the lateral direction of the vehicle body, and the floor panel 3 is provided with a floor cross member 39 disposed on the battery lower module inner cross member 37 and elongated in the lateral direction of the vehicle body. The floor cross member 39 is coupled to the battery lower module inner cross member 37.

In addition, a dash upper member 41 elongated in the forward-backward direction of the vehicle body is coupled between the dash cross member 11 and the floor cross member 39.

Therefore, a rigid structure is formed such that the coupling structure of the dash cross member 11 and the integrated-battery front cross member 9 is connected to the coupling structure of the floor cross member 39 and the battery lower module inner cross member 37 in the forward-backward direction through the dash upper member 41.

Therefore, as illustrated in FIG. 10, load transmitted from the front side of the vehicle body to the rear side of the vehicle body is effectively dispersed and supported by the lattice structure formed by the integrated-battery front cross member 9 and the battery lower module inner cross member 37, whereby the battery cells disposed behind the integrated-battery front cross member 9 may be protected more effectively.

For reference, transmission of load is indicated by the arrows in FIGS. 8 and 10.

Here, it is preferable for the battery accommodation space 5 in which the battery cells are substantially accommodated to be provided behind the battery lower module inner cross member 37.

That is, although the space in front of the battery lower module inner cross member 37 is a space defined on the battery tray 7, it is preferable to place battery-related electrical components such as a battery management system (BMS) or a power relay assembly (PRA) in the space in front of the battery lower module inner cross member 37, rather than directly placing the battery cells, thereby avoiding or minimizing direct impact to the battery cells in the event of accident such as frontal collision of the vehicle.

Meanwhile, in this embodiment, the floor panel 3 is formed of an extruded material in a shape in which a plurality of closed sections is connected to each other. The floor cross member 39 is integrally formed with the floor panel 3 by the highest protruding closed section among the closed sections of the floor panel 3.

Of course, the floor cross member 39 may be provided separately from the floor panel 3. However, as in the present disclosure, when the floor cross member 39 is integrally formed with the floor panel 3, it is possible to form a more simple and robust structure.

The battery tray 7 is provided with lower module outer side members 43, a lower module outer front cross member 45, and a lower module outer rear cross member 47 to surround the outer periphery of the battery accommodation space 5. Gaskets 49 are provided on the upper surfaces of the lower module outer side members 43, the lower module outer front cross member 45, and the lower module outer rear cross member 47.

The lower module outer front cross member 45 located on the front side of the battery tray 7 is coupled to the lower side of the integrated-battery front cross member 9, with the gasket 49 interposed therebetween. The lower module outer rear cross member 47 located on the rear side of the battery tray 7 is coupled to the lower side of the integrated-battery rear cross member 13, with the gasket 49 interposed therebetween. The lower module outer side members 43 of the battery tray 7 are coupled to the lower sides of the side sills 1, with the gaskets 49 interposed therebetween.

For reference, the gaskets 49 are coupled in a pressed state between the lower module outer front cross member 45 and the integrated-battery front cross member 9, between the lower module outer rear cross member 47 and the integrated-battery rear cross member 13, and between the lower module outer side members 43 and the side sills 1. However, it is difficult to express such a coupling structure of the gaskets 49 in the drawings, and thus the gaskets 49 are illustrated as protruding toward the integrated-battery front cross member 9, the integrated-battery rear cross member 13, and the side sills 1, which are located above the battery tray 7.

As described above, since the upper side of the entire outer periphery of the battery tray 7 is coupled to the integrated-battery front cross member 9, the integrated-battery rear cross member 13, and the side sills 1, with the gaskets 49 interposed therebetween, it is possible to secure the watertightness of the battery accommodation space 5.

As is apparent from the above description, the present disclosure provides an electric vehicle structure capable of increasing the cruising range of a vehicle by increasing the number of batteries mounted therein while minimizing increase in the weight of a vehicle body and securing performance against various types of collisions of the vehicle.

Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims.

1. An electric vehicle structure comprising:
a first side sill positioned on a first side of a vehicle body and a second sill positioned on a second side of the vehicle body;
a floor panel having a first side end fixed to the first side sill and a second side end fixed to the second sill;
a battery tray coupled to a lower side of each of the first side sill and second side sill to define a battery accommodation space together with the floor panel;
an integrated-battery front cross member elongated in a lateral direction of the vehicle body, the integrated-battery front cross member being coupled to the first side sill at one end and coupled to the second side sill at an other end, and connecting a front side of the battery tray and the floor panel; and
a dash cross member connected to the floor panel and to a front upper side of the integrated-battery front cross member, the dash cross member being elongated in the lateral direction of the vehicle body.

2. The electric vehicle structure according to claim 1, wherein the dash cross member has a sectional shape in which a plurality of closed sections are connected to each other, and is configured to protrude outwardly from a dash panel.

3. The electric vehicle structure according to claim 1, wherein the dash cross member has a shape covering both an upper surface of the floor panel and a front surface of the integrated-battery front cross member, and is coupled to the floor panel and the integrated-battery front cross member.

4. The electric vehicle structure according to claim 3, further comprising a plurality of front side members connected to a front side of the dash cross member,
wherein the dash cross member is connected to a first A-pillar coupled to the first side sill at a first end, and connected to a second A-pillar coupled to the second side sill at a second end.

5. The electric vehicle structure according to claim 4, further comprising a front sub-frame positioned under the plurality of front side members,
wherein the front sub-frame is mounted such that rear end portions of the front sub-frame is supported on a lower side of the dash cross member.

6. The electric vehicle structure according to claim 4, wherein the dash cross member is connected to the first and second A-pillars through dash cross extensions.

7. The electric vehicle structure according to claim 6, wherein the plurality of front side members are coupled to the dash cross member through a plurality of front side rear lower members coupled to rear sides of the front side members, and
wherein the plurality of front side rear lower members are coupled at rear sides thereof to the dash cross member and the integrated-battery front cross member.

8. The electric vehicle structure according to claim 7, wherein the dash cross member has a sectional shape extending from the floor panel and a front upper side of the integrated-battery front cross member toward rear sides of the plurality of front side members, and
wherein the plurality of front side rear lower members extend from rear sides of the plurality of front side members, and expand in a vertical direction to cover front, upper, and lower sides of the dash cross member.

9. The electric vehicle structure according to claim 8, further comprising a plurality of extension side members coupled to the plurality of front side rear lower members and to the dash cross extensions so as to connect the plurality of front side members to the first and second A-pillars while defining closed spaces surrounding end portions of the dash cross member.

10. The electric vehicle structure according to claim 9, wherein the dash cross extensions are integrally formed with extension upper member portions curved in a shape extending in a direction from a front side of the vehicle body toward a rear upper side of the vehicle body, while defining closed spaces together with the extension side members and extension lower member portions curved in a shape extending in a direction from a front side of the vehicle body toward a rear lower side of the vehicle body.

11. The electric vehicle structure according to claim 10, wherein the extension side members are integrally formed with extension side front upper member portions curved in a shape extending in a direction from a front side of the vehicle body toward a rear upper side of the vehicle body, while corresponding to the extension upper member portions of the dash cross extensions.

12. The electric vehicle structure according to claim 3, wherein the battery tray is provided with a battery lower module inner cross member spaced backward from the integrated-battery front cross member and elongated in the lateral direction of the vehicle body;
wherein the floor panel includes a floor cross member positioned on the battery lower module inner cross member and elongated in the lateral direction of the vehicle body; and
wherein the floor cross member is coupled to the battery lower module inner cross member.

13. The electric vehicle structure according to claim 12, further comprising a dash upper member elongated in a forward-backward direction of the vehicle body and coupled between the dash cross member and the floor cross member.

14. The electric vehicle structure according to claim 12, wherein the floor panel is formed of an extruded material in a shape in which a plurality of closed sections are connected to each other; and
wherein the floor cross member is integrally formed with the floor panel by a highest protruding closed section among the closed sections of the floor panel.

15. The electric vehicle structure according to claim 12, wherein the battery accommodation space is provided behind the battery lower module inner cross member.

16. The electric vehicle structure according to claim 3, wherein the battery tray is provided with a plurality of lower module outer side members, a lower module outer front cross member, and a lower module outer rear cross member to surround an outer periphery of the battery accommodation space; and
wherein the electric vehicle structure further comprises a gasket positioned on each of upper surfaces of the plurality of lower module outer side members, the lower module outer front cross member, and the lower module outer rear cross member.

17. The electric vehicle structure according to claim 16, wherein the lower module outer front cross member located on a front side of the battery tray is coupled to a lower side of the integrated-battery front cross member, with the gasket interposed therebetween;
wherein the lower module outer rear cross member located on a rear side of the battery tray is coupled to a lower side of the integrated-battery rear cross member, with the gasket interposed therebetween; and
wherein the plurality of lower module outer side members of the battery tray are coupled to lower sides of the first and second side sills, with the gasket interposed therebetween.
